(19) United States
(12) Patent Application Publication
(10) Pub. No.: US 2026/0079815 A1
(43) Pub. Date: Mar. 19, 2026

(54) Unified Software Version Comparison

(71) Applicant: The Travelers Indemnity Company, Hartford, CT (US)

(72) Inventors: Ashish Dwivedi, Cumming, GA (US); Jaroslaw Paluch, Round Rock, TX (US); Krishna K. Karna, Southlake, TX (US); Vishal Srivastava, St Augustine, FL (US); Ratnesh Dave, Bloomington, IL (US); Arpan S. Patel, South Windsor, CT (US)

(21) Appl. No.: 18/888,570

(22) Filed: Sep. 18, 2024

(51) Int. Cl. G06F 11/36

(52) U.S. Cl. CPC G06F 11/3604

(57) ABSTRACT

Techniques for software quality assurance are disclosed. A quality assurance system monitors payloads generated by multiple software environments. Responsive to detecting payloads for a particular software environment, the system selects a reference payload generated by a baseline version of the environment and a test payload generated by a modified version of the environment. The system cleanses the selected payloads by identifying elements to be excluded from comparison. The system then determines differences by comparing the test payload to the baseline payload. Based on the comparison, the system generates a report identifying the differences for debugging.

### BACKGROUND

Software quality assurance determines whether software functions as intended. In some instances, software quality assurance verifies that a new or revised software component does not adversely impact the functionality of other software components in an existing system. For example, after updating a user interface of a customer relationship management (CRM) system, developers may conduct regression testing to ensure that the update does not degrade the performance of a customer data retrieval component. Additionally, integration testing may be conducted to ensure the updated user interface component seamlessly interacts with the other components of the CRM system.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example architecture of a software testing environment in accordance with one or more embodiments;

FIG. 2 illustrates an example architecture of a quality assurance system in accordance with one or more embodiments;

FIG. 3 illustrates a functional architecture of the example quality assurance system in accordance with one or more embodiments;

FIGS. 4A and 4B illustrate an example set of operations for comparing payloads in accordance with one or more embodiments;

FIG. 5 illustrates an example of a data structure for logging results of payload comparisons in accordance with one or more embodiments; and

FIG. 6 illustrates an example report from comparing payloads in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

### 1. General Overview

The present disclosure is directed to techniques for software quality assurance and, more specifically, to verifying whether modified software is compatible with existing software. Embodiments compare payloads generated by different versions of software to verify whether a payload of a modified version differs from a payload of a reference version. The software may be a computer-executable application, component, module, service, tool, or the like. Payloads include the content of a file, document, message, or data structure generated by the software, but exclude metadata, headers, or other information that contains or describes the file, document, message, or data structure.

In one or more embodiments, a quality assurance system monitors payloads generated by multiple software environments. Responsive to detecting a set of payloads for a particular software environment, the system identifies a reference payload generated by a baseline version of the particular software environment and at least one test payload generated by a modified version of the software environment. The system cleanses the selected payloads by identifying elements to be excluded from comparison. The system then determines differences by comparing the test payloads to the baseline payload. Based on the comparison, the system generates a report identifying the differences for debugging.

One or more embodiments described in this Specification and/or recited in the claims may not be included in this General Overview section.

### 2. Practical Applications, Advantages & Improvements

Systems and methods in accordance with the present disclosure improve the functioning of computing systems by enhancing the flexibility, efficiency, accuracy, repeatability, and reliability of computer-implemented quality assurance systems. Embodiments agnostically process payloads to minimize mismatches during comparisons regardless of the formatting of payloads that are output by different software versions. By doing so, computing systems perform quality assurance testing more accurately and faster than current techniques, which reduces computing resource consumption.

Agnostically processing payloads also improves the compatibility of quality assurance systems within diverse software environments, such as software as a service (SaaS) cloud environments, by allowing systems to handle a wide range of inputs and by preventing false positives. Whereas conventional systems generate false positives during quality assurance testing, the disclosed data-agnostic systems streamline quality assurance testing across various software versions, eliminate manual adjustments, reduce computing time, increase operational efficiency, and minimize false positives.

Additionally, some embodiments are implemented using multithreaded computing infrastructure that concurrently compares payloads from multiple software components. The use of a multithreaded computing infrastructure enables quality assurance systems to process more data in a shorter time frame compared to traditional sequential methods, increasing the speed of testing and, thereby, reducing the consumption of computing resources.

Moreover, some embodiments continuously monitor for payloads to detect updated versions and execute comparisons in real-time or near real-time. By triggering quality assurance testing in response to detecting payloads, embodiments conserve time and computing resources, as well as prevent the introduction of errors that may compromise software. Furthermore, embodiments provide continuous verification and feedback as payloads are generated. Unlike conventional quality assurance systems that are executed at set intervals or after major updates, embodiments detect and test payloads in real-time to identify errors early in a software development process. The early detection leads to faster identification and resolution of issues, which improves software stability and reduces timelines.

Still further, embodiments reduce computing resource consumption by improving the accuracy and efficiency of quality assurance testing. Conventional techniques may require repeated tests, manual oversight, or long processing times due to false positives or incomplete comparisons. In contrast, one or more embodiments optimize computing resource use by accurately targeting relevant components and reducing redundant operations. Reduced resource consumption results in more efficient use of computational resources consumed by testing.

### 3. Software Quality Assurance Environment Architecture

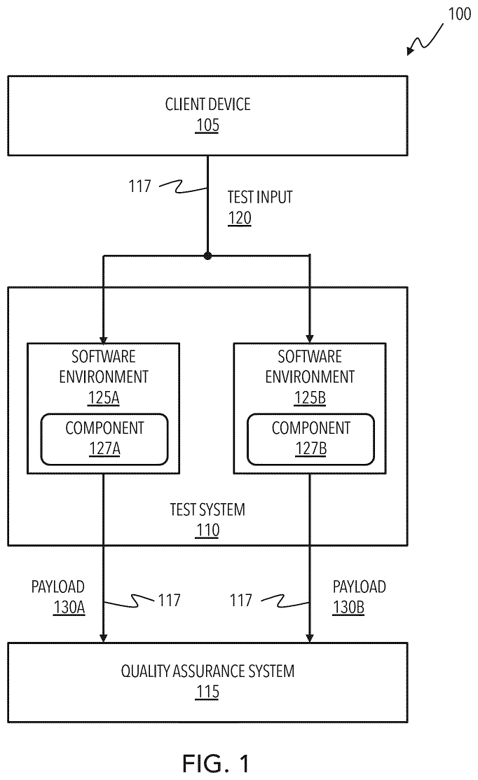

FIG. 1 shows a block diagram illustrating an example architecture of a software testing environment 100 for implementing systems, methods, and computer program products in accordance with aspects of the present disclosure. The example environment 100 includes a client device 105, a test system 110, and a quality assurance system 115, in communication via one or more communication links 117. The components illustrated in FIG. 1 may be local to or remote from each other. Each component may be distributed over multiple applications and/or machines. Multiple components may be combined into one application and/or machine. Operations described with respect to one component may instead be performed by another component.

The communication links 117 transmit data between the client device 105, the test system 110, and the quality assurance system 115. The communication links 117 may comprise any combination of wired and/or wireless links, any combination of one or more types of networks, including the Internet, an intranet, a wide-area network (WAN), a local-area network (LAN), a wireless network, a digital subscriber line (DSL) network, a frame relay network, an asynchronous transfer mode (ATM) network, and a virtual private network (VPN).

The client device 105 comprises a personal computing device, such as a desktop computer, a workstation, a remote terminal, a laptop computer, a tablet computer, a smartphone, or the like. In one or more embodiments, the client device 105 includes a computer-user interface comprising hardware and/or software configured to facilitate communications between a user and the client device 105 for creating, modifying, managing, and configuring software. Users of the client device 105 may include, for example, software developers, programmers, and/or engineers who create and maintain software.

The test system 110 comprises one or more computing systems that execute software environments 125A and 125B for software testing and evaluation. The test system 110 runs various test cases and scenarios to verify whether software behaves as expected and meets predefined specifications. Some embodiments of the software environments 125A and 125B comprise versions, configurations, and contexts of software applications in which software components are developed, tested, and deployed. For example, the software environments 125A and 125B may comprise testing environments executing different versions of a CRM platform. In some embodiments, the software environment 125A replicates a production version of an application and includes an original or unmodified version of a software component 127A. The software environment 125B substantially mirrors the software environment 125A, but includes a software component 127B, which comprises a new or modified version of the software component 127A. For example, the software component may comprise a candidate user interface component with updates to a deployed user interface component 127A of the CRM platform.

By executing the test input 120, the software environments 125A and 125B output respective payloads 130A and 130B to the quality assurance system 115. The test input 120 includes data and routines for testing the components 127A and 127B. For example, the test input 120 may comprise a script that tests boundary conditions representing scenarios near, at, and/or beyond acceptable limits of the components 127A and 127B. Additionally, or alternatively, the test input 120 may test nominal conditions representing typical real-world scenarios. The payloads 130A and 130B may be formatted as XML, JSON, HTML, TXT, or another standard file format. The test system 110 may be configured to store any payloads 130 in a storage system accessible by the quality assurance system 115.

The quality assurance system 115 comprises one or more computing systems that process and compare the payloads 130A and 130B output by the software environments 125A and 125B, respectively. Embodiments of the quality assurance system 115 automate and improve assurance testing of upgraded software by formatting, validating, cleansing, and sorting, the payloads 130A and 130B. Doing so allows the quality assurance system 115 to compare the payloads 130A and 130B having different formats (e.g., JSON and XML) while minimizing comparison errors, such as false positives. Example differences identified may include structural mismatches, such as the presence or absence of keys and variations in the nesting of objects and arrays. The differences may also include value mismatches, the same the keys having different data (e.g., “name”: “John” vs. “name”: “Jane”). The differences may further include value type mismatches, such as a key having a string in one file and a number in the other (e.g., “age”: “30” vs. “age”: 30). Additionally, the differences may include changes in the order of elements in, for example, arrays.

In a non-limiting example of the environment 100, the software environment 125A replicates an existing web system that customers access via the Internet to obtain and manage online services. The software environment 125B substantially replicates the software environment 125A, but executes a modified version of the web system. For example, the modified version may include a front-end component 127B that updates a current front-end component 127A. While the front-end component 127A has been updated, the back end of the system may be unchanged and demand that payloads 130A and 130B output from the front-end components 127A and 127B match. To verify the front end component 127B, the test input 120 may be executed by both software environments 125A and 125B using their respective components 127A and 127B. The test script may, for instance, automate the login functionality of the front end, wherein the script inputs values for user interface input elements, such as username, password, age, address, etc. Executing the test script causes the software environments 125A and 125B to generate payloads 130A and 130B as JSON files including data generated by the front-end components 127A and 127B as key-value pairs. The quality assurance system 115 captures the payloads 130A and 130B and compares them. Based on the comparison, the quality assurance system 115 identifies mismatches that may cause errors in the back end of the web service.

While FIG. 1 illustrates a single test system 110 that includes both software environments 125A and 125B, it is understood that embodiments of the environment 100 consistent with the present disclosure may include multiple test systems 110 that each include one of software environments 125A and 125B. For example, some embodiments of the quality assurance system 115 may be implemented in a SaaS cloud environment in which multiple processors execute multiple threads concurrently by processing many comparisons in parallel. Additionally, while the client device 105, the test system 110 and the quality assurance system 115 are described herein as providing certain features and functions, it is understood that some or all of the features and functions may, instead, be executed at the test system 110.

### 4. Quality Assurance System Architecture

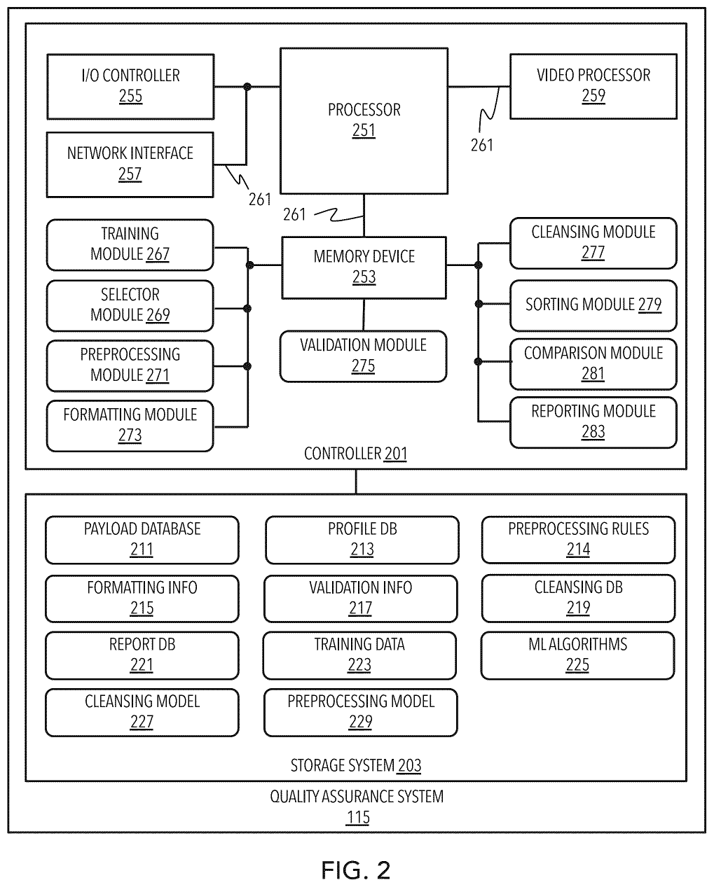

FIG. 2 illustrates a block diagram of an example system architecture of the quality assurance system 115 in accordance with one or more embodiments. The quality assurance system 115 includes hardware and software that perform processes and functions described herein. In one or more embodiments, the quality assurance system 115 may include more or fewer components than the components illustrated in FIG. 2. The components illustrated in FIG. 2 may be local to or remote from each other. Each component may be distributed over multiple applications and/or machines. Multiple components may be combined into one application, package, and/or machine. Furthermore, operations described with respect to one component may instead be performed by another component.

The quality assurance system 115 includes a controller 201 and one or more storage devices, e.g., storage system 203. In accordance with aspects of the present disclosure, the controller 201 and the storage system 203 are configured to perform specialized functions and operations, consistent with embodiments described herein. Additionally, the quality assurance system 115 may include one or more input / output (I/O) devices for interacting with users. In some embodiments, users interact with the quality assurance system 115 via I/O devices of a remote computer (e.g., client device 105).

The storage system 203 comprises one or more computer-readable, non-volatile hardware storage devices that store information and program instructions. The storage system 203 may comprise any type of storage unit and/or device (e.g., a file system, database, collection of tables, or any other storage mechanism) for storing data. Additionally, the storage system 203 may include multiple different storage units and/or devices. The multiple different storage units and/or devices may or may not be of the same type or located at the same physical site. Furthermore, the storage system 203 may be implemented or executed on the same computing system as the quality assurance system 115. Additionally, or alternatively, the storage system 203 may be implemented or executed on a computing system separate from the quality assurance system 115. The storage system 203 may be communicatively coupled, wired and/or wirelessly, to the quality assurance system 115 via a direct connection or via a network.

One or more embodiments of the storage system 203 store a payload database 211, a profile database 213, preprocessing rules 214, formatting information 215, validation information 217, cleansing database 219, a report database 221, training data 223, machine learning algorithms 225, a cleansing model 227, and a preprocessing model 229. The payload database 211 comprises one or more data structures storing payloads (e.g., payloads 130) obtained from software environments (e.g., software environments 125A and 125B). For example, the payloads may comprise data files formatted in XML, JSON, CSV, HTML, TXT, or other standard formats output by the software environments.

The profile database 213 comprises one or more data structures describing payloads. Individual profiles comprise sets of attributes of respective payloads, such as file type, file source, source version, file name, file size, and/or creation date. The attributes may include elements extracted from the payloads. For example, the attributes may include descriptive information and keys obtained from key-value pairs included in the content of a JSON file.

The preprocessing rules 214 include logical and/or heuristic rules for determining whether to perform one or more preprocessing operations on payloads. The preprocessing operations include one or more of formatting, validation, cleansing, and sorting. Based on the profiles of the payloads, the corresponding rules may be applied to select one or more preprocessing operations for execution on the payloads. For example, if the file type of the reference payload is a text format and the file type of the test payload is a JSON format, then the rules may indicate that the test payload requires formatting and that both payloads require validation, cleansing, and sorting. Whereas, if the file types of the reference payload and test payload are JSON format, then the rules may indicate that the payloads merely require cleansing and sorting.

The formatting information 215 includes rules and logic for transforming payloads into different formats for comparison with other payloads. Some embodiments flatten reference payloads and test payloads into a common file format. For example, the formatting information may include formatting rules for adding line breaks, indentation, and the like. Additionally, the formatting information may include rules for parsing information from JSON and HTML files and storing the parsed information as TXT files. Some embodiments transform test payloads into a format of the reference payload. For example, the formatting information 215 may include formatting rules that map HTML elements of the test payload to JSON keys and values of the reference payload. Additionally, the formatting information 215 may include transformation logic that parses and extracts information into XML, JSON, CSV, HTML, TXT formats and the like.

The validation information 217 comprises one or more data structures storing information for determining whether payloads are valid. Some embodiments of the validation information 217 include syntaxes and grammars corresponding to different file types and protocols. For example, the validation information 217 may store a JSON schema and a dictionary for validating JSON files.

The cleansing database 219 includes data structures that store information indicating data to be excluded from comparison of payloads. Examples of excluded information include public identifiers, timestamps, transaction identifiers, system identifiers, account numbers, policy numbers, job numbers, etc. Some embodiments of the cleansing database 219 are searchable based on payload source. For example, the cleansing database 219 may store one or more cleanse lists corresponding to a particular software environment or component. The cleanse lists may be user-generated and user-curated sets of variables, data elements, arrays, and/or records. Additionally, or alternatively, the cleanse lists comprise sets of variables, data elements, arrays, and/or records generated for particular payloads or types of payloads by the cleansing model 227.

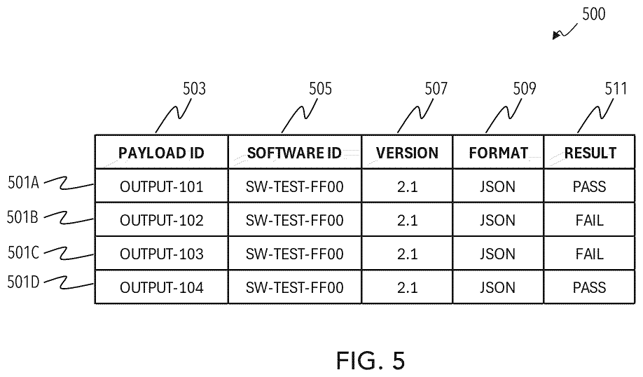

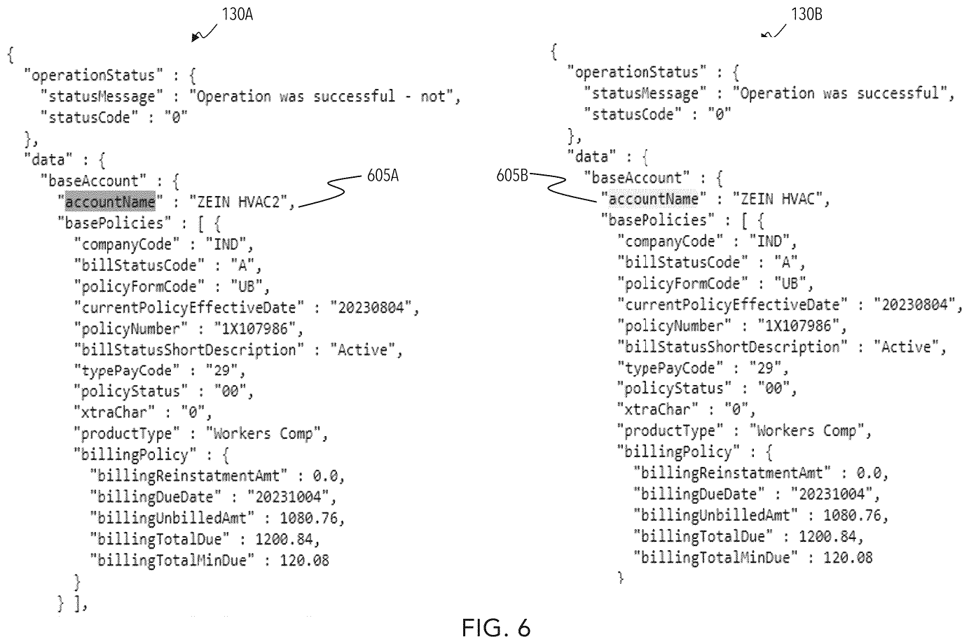

The report database 221 comprises one or more data structures and/or files that store report information generated by comparing payloads. The report information indicates whether or not test payloads passed or failed a comparison due to including one or more mismatches, as shown in FIG. 5, for example. Additionally, the report information indicates differences identified by the comparisons. The differences may include added elements, removed elements, and/or modified elements. For example, as illustrated in FIG. 6, the report information may include copies of a reference payload 130A and a test payload 130B having elements 605A and 605B marked up with indicators specifying an old value and a new value for each mismatch.

The training data 223 comprises one or more data structures that store sets of training data for training machine learning models. The training data sets may include training payloads along with data sets that include labels indicating elements included in cleanse lists of respective payloads. Additionally, the training data sets can include attributes corresponding to payloads along with labels indicating appropriate sets of preprocessing operations for the scanning respective payloads.

The machine learning algorithms 225 comprise one or more algorithms that are iterated to train machine learning models to map a set of input variables to an output variable. In particular, the machine learning algorithms are configured to train one or more cleansing models 227 to compute a set of elements included in the cleanse lists. A machine learning algorithm generates a target model such that the target model best fits the datasets of training data to the labels of the training data. Additionally, or alternatively, a machine learning algorithm generates a target model such that when the target model is applied to the sets of the training data, a maximum number of results determined by the target model match the labels of sets of the training data. Different target models may be generated based on different machine learning algorithms and/or different sets of training data. The algorithms include supervised components and/or unsupervised components. Algorithms, such as linear regression, logistic regression, linear discriminant analysis, classification and regression trees, naïve Bayes, k-nearest neighbors, learning vector quantization, support vector machine, bagging and random forest, boosting, backpropagation, and/or clustering may be used.

The cleansing model 227 comprises a trained machine learning model that determines variables, data elements, arrays, and/or records to be excluded from cleanse lists. In some embodiments, the cleansing model 227 comprises a neural network trained to calculate elements included in a cleanse list based on elements of a target payload.

The preprocessing model 229 comprises a trained machine learning model that determines sets of preprocessing steps to be applied to particular payloads based on attributes of the individual payloads. In some embodiments, the preprocessing model 229 is a clustering machine learning model trained to determine a cluster for a target payload and select a set of corresponding preprocessing steps. In some other embodiments, the preprocessing model 229 comprises a supervised machine learning model trained to, based on attributes of a target payload, determine a set of preprocessing operations, including one or more of formatting, validation, cleansing, and sorting.

Still referring to FIG. 2, the controller 201 may include one or more processors 251, one or more memory devices 253, an input/output (I/O) controller 255, a network interface 257, and a video processor 259. Additionally, the controller 201 includes at least one communication channel 261 (e.g., a data bus) by which the processor 251 communicates with the memory device 253, the input/output (I/O) controller 255, the network interface 257, and the video processor 259.

The processor 251 executes computer program instructions (e.g., an operating system and/or application programs), which can be stored in the memory device 253 and/or storage system 203. The processor 251 may comprise one or more general-purpose processors, special-purpose processors, or other programmable data processing apparatuses providing the functionality and operations detailed herein.

The memory device 253 includes a local memory operative during execution of program instructions. In some embodiments, the memory device 253 may include random access memory (RAMs) units, read only memory (ROMs), flash memory (e.g., solid state drives (SSDs)), electrically erasable/programmable read only memory (EEPROMs), etc. It should be appreciated that in some embodiments, communication between the memory device 253, the storage system 203, and the processor 251, encompasses the processor 251 accessing the memory device 253 and/or the storage system 203, exchanging data with the memory device 253 and/or the storage system 203 (e.g., reading/writing data to the memory device 253), and/or storing data to the memory device 253 and/or the storage system 203.

The network interface 257 comprises a digital device that performs network communication with external devices. For example, the network interface 257 may connect the quality assurance system 115 to a local area network (LAN), a wide area network (WAN), or the Internet. The network interface 257 may include wired and/or wireless communication hardware.

The video processor 259 communicates with the processor 251 to render at least some of the graphics, displays, and information displayed using a display device. In some embodiments, the video processor 259 includes one or more data processors, controllers, and/or graphics cards for processing the images, outcomes, and/or animated displays and coordinating the processed data to be displayed between, among, or across any or all display devices.

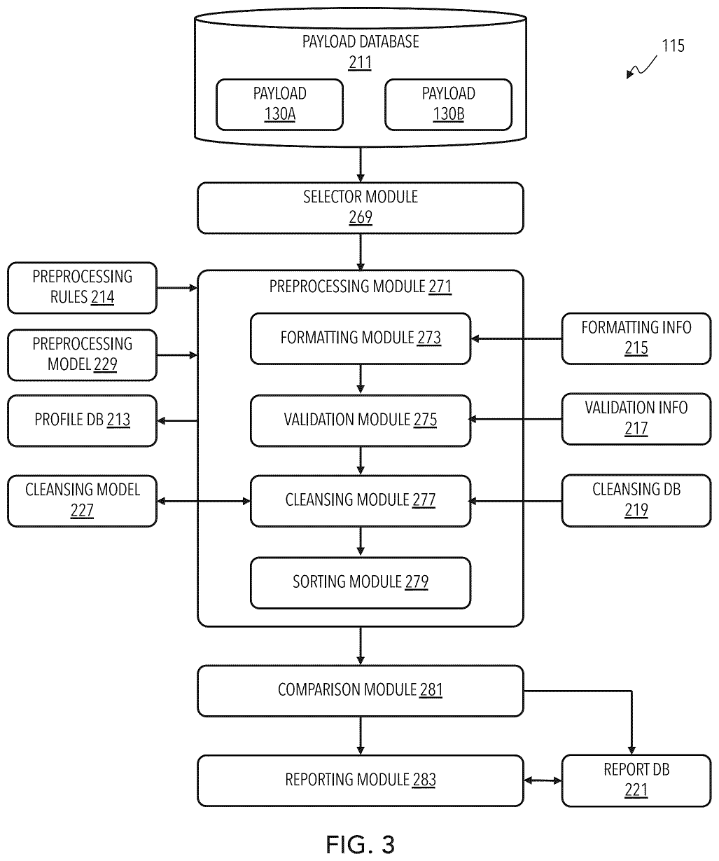

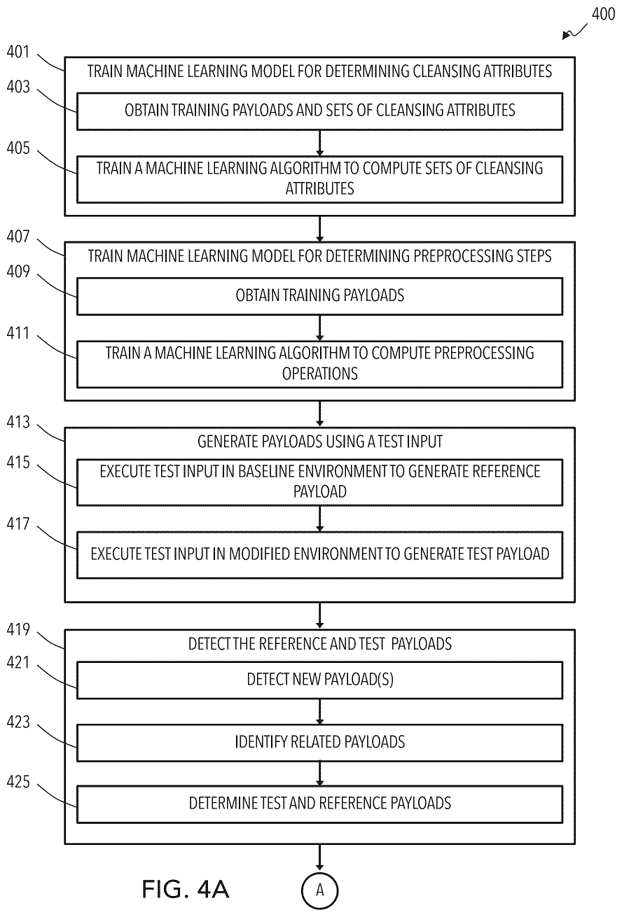

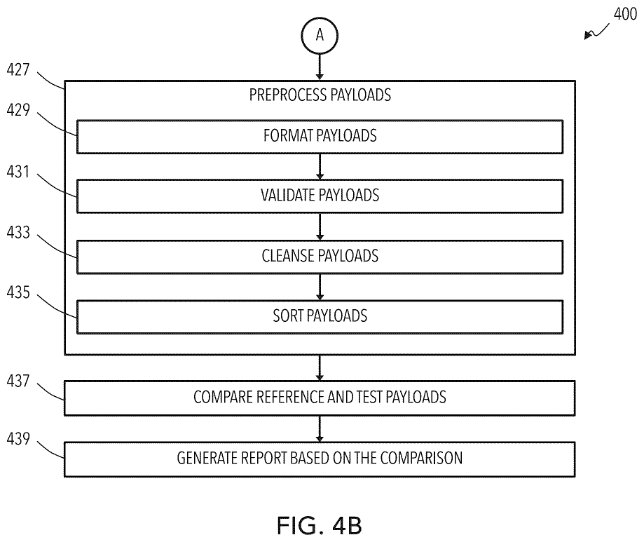

The controller 201 includes hardware and/or software configured to perform operations described herein. Example operations are described below with reference to FIGS. 3, 4A, and 4B. The controller 201 executes computer-readable program instructions, such as an operating system and application programs that are stored in memory devices and/or the storage system 203. Moreover, the controller 201 executes program instructions of a training module 267, a selector module 269, a preprocessing module 271, a formatting module 273, a validation module 275, a cleansing module 277, a sorting module 279, a comparison module 281, and a reporting module 283.

As detailed below, the training module 267 trains the one or more cleansing models 227 by iteratively applying sets of training data 223, e.g., in a training database, to the machine learning algorithms 225. The selector module 269 monitors the payload database 211 to detect payloads or sets of related payloads stored in the payload database. The preprocessing module 271 evaluates payloads and determines whether to execute one or more preprocessing operations on the payloads using the preprocessing rules 214 and/or the preprocessing model 229. The formatting module 273 modifies payload files to place them in a common format for comparison. The validation module 275 determines whether the formatted (or reformatted) payloads are well-formed. The cleansing module 277 filters the payloads using cleanse lists to exclude information from comparisons. The sorting module 279 parses the content of the payloads and places the content of the payloads in an order. The comparison module 281 compares the payloads to identify differences in their respective data, if any. The reporting module 283 generates and outputs a report indicating the differences identified by the comparison module 281.

### 5. Quality Assurance System Functional Architecture

FIG. 3 illustrates a functional block diagram of the example quality assurance system 115 in accordance with one or more embodiments. The quality assurance system 115 includes a payload database 211, a profile database 213, preprocessing rules 214, formatting information 215, validation information 217, a cleansing database 219, a report database 221, a cleansing model 227, a selector module 269, a preprocessing module 271, a formatting module 273, a validation module 275, a cleansing module 277, a sorting module 279, a comparison module 281, and a reporting module 283, each of which can be the same or similar to those previously described above. The components illustrated in FIG. 3 may be local to or remote from each other. Each component may be distributed over multiple applications and/or machines. Multiple components may be combined into one application and/or machine. Operations described with respect to one component may instead be performed by another component.

The payload database 211 stores payloads, such as payloads 130A and 130B, generated by various software environments (e.g., software environments 125A and 125B). As described above, the software environments include different versions of a particular software application. The different versions may be used to verify that payloads output by a first version of the software application match payloads output by a second version. For example, the reference payload 130A may be generated by executing a test script (e.g., test input 120) using a baseline version of the software environment (e.g., environment 125A) including an unmodified component (e.g., component 127A). The test payload 130B may be generated by executing the same test script using an updated version of the software environment (e.g., environment 125B) including a modified component (e.g., component 127B).

The selector module 269 monitors the payload database 211 to detect payloads for comparison. For example, the selector module 269 may detect the addition of the payloads 130A and 130B. Additionally, the selector module 269 identifies the payloads 130A and 130B as related based on, for example, the payloads'130A and 130B respective file information, such as storage times, creation times, file sources, versions, file names, and other file metadata. Some embodiments of the selector module 269 detect the addition of the payloads 130A and 130B by querying the content of the payload database 211 to generate an ordered list of the stored payloads. Additionally, or alternatively, embodiments of the selector module 269 detect the payloads 130A and 130B by subscribing to events published by the quality assurance system 115. For example, in a cloud computing environment, the selector module 269 may subscribe to events indicating changes in storage buckets or database updates.

The preprocessing module 271 evaluates the related payloads 130A and 130B and determines one or more preprocessing operations from a set of preprocessing operations for optimizing the comparison process. The preprocessing operations include formatting, validation, cleansing, and sorting, which may be performed by the formatting module 273, the validation module 275, the cleansing module 277, and the sorting module 279, respectively. Some embodiments apply the preprocessing rules 214 to determine the preprocessing operations suitable for the payloads 130A and 130B based on file information and attributes of the payloads 130A and 130B. Some embodiments apply the preprocessing model 229 to determine the preprocessing operations suitable for the payloads 130A and 130B based the attributes. The preprocessing module 271 may extract and store the attributes of the individual payloads 130A and 130B in the profile database 213. For example, the preprocessing module 271 may use Natural Language Processing (NLP) techniques to extract attributes, such as title, file type, file source, version (e.g., a version number), keywords, and/or tags.

Based on file information and/or attributes of the payloads 130A and 130B, the preprocessing module 271 applies the preprocessing rules 214 to determine which preprocessing operations to execute on the payloads 130A and 130B. For example, based on the file types of the payloads 130A and 130B, the preprocessing module 271 may determine that the formatting module 273 should be executed to place the payloads 130A and 130B into a common format. Additionally, based on the file type being unstructured (e.g., TXT), rather than structured (e.g., JSON), the preprocessing module 271 may determine whether the validation module 275 should be applied to validate the content of the payloads 130A and 130B. Further, based on the payload source and attributes, the preprocessing module 271 may determine whether the cleansing module 277 should be applied to the payloads 130A and 130B.

The formatting module 273 modifies the payloads 130A and 130B to place the payloads 130A and 130B in a common format for comparison. For instance, the reference payload 130A may be in TXT format and the test payload 130B may be in JSON format. Some embodiments identify the format of the reference payload 130A as the target format and, accordingly, convert the test payload 130B to the target format. The formatting module 273 may convert the format by applying predetermined rules and schemas stored in the formatting information 215. For example, formatting module 273 may parse the JSON formatted test payload 130B into a data structure, and serialize that data structure into a TXT format.

The validation module 275 determines whether the payloads 130A and 130B are well-formed based on the validation information 217. Well-formed payloads have syntaxes and grammars that comply with rules applied by parsers. The validation module 275 may obtain the syntaxes and grammars corresponding to the file type of the payloads 130A and 130B from the validation information 217. For example, using JSON syntaxes and grammar rules stored in the validation information 217, the validation module 275 may determine that a JSON payload is well-formed because individual elements are labeled with matching closing tags and structured with proper nesting.

The cleansing module 277 processes the payloads 130A and 130B based on a cleanse list in the cleansing database 219 to filter elements that are excluded from the comparison process. Excluded elements may comprise attributes, keys, and/or values that may change from payload to payload. For example, a software module may generate records with unique transaction identifiers. Accordingly, the cleanse lists may identify values of a “transaction ID” key in payloads 130A and 130B for exclusion from the comparison. Exclusion may include removing the key-value pair from the payload or changing the values to a predetermined dummy value. As discussed previously, the cleanse lists may be created and maintained by developers or other users. Additionally, or alternatively, some embodiments generate or supplement the cleanse lists by determining information to be cleansed using the cleansing model 227.

The sorting module 279 parses the content of the payloads 130A and 130B and organizes the parsed content in a particular order. Some embodiments parse the payloads 130A and 130B and sort the parsed elements. For example, where the payloads 130A and 130B are JSON files, the sorting module 279 may sort the elements by their keys.

The comparison module 281 compares the payloads 130A and 130B to identify differences, if any. The comparison module 281 traverses through the data structures of both payloads 130A and 130B and compares the individual elements. Some embodiments use recursive traversal for nested structures or simple iteration for flat (i.e., unnested) structures. For example, where the payloads 130A and 130B are JSON files, after sorting the keys into a consistent order across both files by the sorting module 279, the comparison module 281 may compare the payloads 130A and 130B line by line or using a JSON DIFF tool to identify differences. Differences may include missing elements, added elements, matching elements having different values, and/or arrays or objects having different lengths or containing different elements. The comparison module 281 may then store the identified differences in the report database 221.

The reporting module 283 generates, stores, and outputs reports indicating whether or not test payloads 130B matched the corresponding reference payload 130A and identifying differences determined by the comparison module 281. The report may specify, for example, line numbers, keys, and values that differ, such that developers or users may identify and address the sources of the differences. The report may also add visual indicators, such as underlines, highlights, fonts, flags, or the like, to the payloads 130A and 130B indicating the differences. For example, FIG. 5 illustrates an example data structure 500 logging results of a comparison of multiple payloads for a particular software environment or component. The data structure may comprise records 501 storing a payload identifier 503, a software identifier 505, a version 507, a format of the payload 509, and a result of the comparison 511. The individual records 501 may be linked to corresponding payloads 130A and 130B annotated with visual indicators of the differences. For example, FIG. 6 illustrates example payloads 130A and 130B including indicators highlighting an element 605A (“AccountName”) having a value (“ZEIN HVAC2”) that is different than a corresponding element 605B having a value (“ZEIN HVAC”).

### 6. Payload Comparison Process

FIGS. 4A and 4B show a flow block diagram illustrating a process 400 including an example set of operations for comparing payloads in accordance with one or more embodiments. One or more operations of the process 400 may be modified, rearranged, or omitted. Accordingly, the particular sequence of operations illustrated in FIGS. 4A and 4B should not be construed as limiting the scope of one or more embodiments.

Referring to FIG. 4A, at block 401, a system (e.g., quality assurance system 115) trains a machine learning model (e.g., cleansing model 227) to determine a set of elements to be cleansed for particular payloads. In some embodiments, generating the cleansing model includes, at block 403, obtaining training datasets (e.g., training data 223 from a training database) comprising payloads and corresponding sets of cleanse lists. The cleanse lists include elements (e.g., attributes, keys, and/or values) that have been excluded or replaced during a comparison of the corresponding payloads. Additionally, generating the cleansing model includes, at block 405, training a machine learning algorithm to compute cleansing elements for a given payload. The machine learning algorithms may comprise a linear regression, logistic regression, linear discriminant analysis, classification and regression trees, naïve Bayes, k-nearest neighbors, learning vector quantization, support vector machine, bagging and random forest, boosting, backpropagation, and/or clustering algorithm. For example, a machine learning algorithm may comprise a neural learning model trained by iteratively applying input-output pairs, and updating the model based on an error function. Additionally, after training the cleansing model, some embodiments continuously collect new labeled data and periodically retrain the neural learning model to improve the model's accuracy and adapt to new payloads.

At block 407, the system trains a machine learning model (e.g., preprocessing model 229) to determine a set of preprocessing operations for particular payloads. In some embodiments, generating the preprocessing model includes, at block 409, obtaining training data comprising payloads, attributes related to those payloads, and corresponding sets of operations. The sets of preprocessing operations include one or more of formatting, validation, cleansing, and sorting, which may be applied to the individual payloads based on the respective attributes of the payloads. In some embodiments, a subject matter expert specifies the preprocessing operations associated with particular payloads.

Additionally, generating the preprocessing model includes, at block 411, training a machine learning algorithm to compute preprocessing operations for a given payload. Using the payload attributes as features, the system computes feature vectors with respective preprocessing operations as labels for training a machine learning algorithm. The machine learning algorithm may comprise a neural network, random forest, or gradient boosting. It is understood that other algorithms may be used. For example, some embodiments may use linear regression, logistic regression, linear discriminant analysis, classification and regression trees, naïve Bayes, k-nearest neighbors, learning vector quantization, support vector machine, and a bagging and/or clustering algorithm.

The training also comprises feeding the feature vectors from the training dataset to the model. During training, the model learns to map the payloads and their attributes to the appropriate sets of preprocessing operations by adjusting the model parameters to minimize prediction error. A subset of the training data can be used to verify that the machine learning model is sufficiently accurate by comparing the preprocessing operations output by the model to the known operations of training payloads. Based on the comparison, a loss function such as Binary Cross-Entropy may be used. Adjusting the model parameters may comprise modifying the learning rate, the number of trees in a random forest, or the architecture of a neural network, to improve performance. Additionally, after training the preprocessing model, some embodiments continuously collect new labeled data and periodically retrain the model to improve the model's accuracy and adapt to new payloads over time.

At block 413, the system generates payloads using a test input (e.g., test input 120). As described above, the test input may be a test script that controls the software environments to perform operations representing test scenarios. The payloads comprise data files including information output by software environments as a result of executing the test input. The individual payloads may comprise any type of data files, including XML, JSON, HTML, TXT, or other standard file format. Generating payloads includes, at block 415, executing the test input using a baseline software environment (e.g., software environment 125A), including an unmodified component (e.g., component 127A) to generate a reference payload (e.g., payload 130A). Additionally, generating payloads includes, at block 417, executing the test input in a modified version of the software environment (e.g., software environment 125B), including a modified component (e.g., component 127B) to generate a test payload (e.g., payload 130B). The system may store the payloads in a searchable payload database (e.g., payload database 211) along with other payloads generated by different environments using different test inputs.

At block 419, the system detects the payloads generated at block 413. Detecting the payloads may include, at block 421, detecting new payloads added to the payload database. For example, the system may periodically query the payload database to generate a time-ordered list of stored payloads. Detecting the payloads may also include, at block 423, identifying related payloads among the payloads in the payload database within a predetermined time window. Based on file data of the detected payload, the system may search the database to identify one or more payloads generated by related software environments. For example, the system may identify related payloads generated by applications having matching software identifiers (e.g., software ID 505).

Detecting the payloads may also include, at block 425, determining the test and reference payloads among those identified at block 419. Based on attributes of the identified payloads, such as file name (e.g., payload ID 503) and version number (e.g., version 507), the system may identify a first payload as a reference payload and identify a second payload as the test payload. For instance, the reference payload may be “version 1.5” and the test payload may be “version 2.1.” Additionally, the attributes of the test payload, such as file source and file name, may indicate the payload or its source environment are test or development versions.

Referring to FIG. 4B, at block 427, the system preprocesses the payloads detected at block 419. Preprocessing may include determining whether to perform one or more operations to optimize the comparison process. The preprocessing operations include formatting, validation, cleansing, and sorting. The system may apply one or more logical or heuristic rules (e.g., preprocessing rules 214) or a trained machine learning model (e.g., preprocessing model 229) that determine whether to perform some or all of preprocessing operation shown in blocks 429 to 435. For example, based on the respective file names, file types, versions, and profiles of the payloads, the system may determine that the payloads should be formatted, validated, cleansed, and/or sorted prior to comparison.

At 429, based on the determination of preprocessing operations, the system formats the reference payload and/or the test payload to place the payloads into a common format. For example, using rules and schemas (e.g., formatting information 215), the system may convert one or both of the payloads to a JSON format. The formatting may include parsing the payloads to extract the information, such as structure, keywords, and/or values from a first structured document. Using the extracted information, the system may generate a second structured document fusing the keywords and values according to the schema and system for the target format.

At block 431, based on the determination of preprocessing operations, the system validates the reference payload and the test payload. Validation includes, for example, determining that individual elements have matching closing tags, and elements are properly nested within one another. Additionally, a well-formed file may contain one and only one root element that encloses all other elements such that the entire content is encapsulated within a single top-level tag. Furthermore, elements of a well-formed file follow syntaxes and grammar rules of the target format.

At block 433, based on the determination of preprocessing operations, the system cleanses the reference payload and the test payload to exclude information from comparison. Some embodiments obtain the cleansing information from a library (e.g., cleansing database 219) by identifying one or more cleanse lists corresponding with the payloads. For example, the system may search a database of cleanse lists based on the source environment (e.g., software ID 505) of the payloads. Using the one or more cleanse lists retrieved from the library, the system cleanses the payloads by removing and/or replacing the elements with dummy information for the values associated with elements in the cleanse list. For example, based on a cleanse list, the system may delete certain key-value pairs from a JSON file. Additionally, or alternatively, the system may replace the values of certain key-value pairs with a predetermined value.

At block 435, based on the determination of preprocessing operations, the system sorts the reference payload and the test payload. The sorting operation places the content of the payloads in an order for comparison. Some embodiments parse the content of the payloads into corresponding data structures, such as dictionaries (objects), lists (arrays), strings, numbers, Booleans, and null values.

At block 437, the system compares the reference payload and the test payload. Comparing includes iterating through the data structures of both payloads to identify differences. During the comparing, the system checks the content of each corresponding line in the reference and test payloads to identify differences, including additions, deletions, and modifications. For example, the difference may be an element that exists in the reference payload but not in the test payload. Additionally, the comparing may recursively traverse through the directory structures of the reference payload and the test payload from the root directory downward. For each directory, the contents are listed and compared. If a file or directory exists in one location but not the other, the system records the difference. As differences are identified, the system records differences in a structured format (e.g., in report database 221).

At block 439, the system generates a report based on the comparison. The report may indicate whether the test payload differed from the reference payload. For example, the report may include a pass/fail indicator wherein the system sets the indicator to fail when the payloads include one or more mismatch. Additionally, the report may indicate the differences identified by during the comparison at block 437. The system may generate a report or output detailing the differences found between the two JSON files including specifics, such as line numbers, keys, and values that differ. For example, as described above, FIG. 5 illustrates an example data structure 500 logging results of a comparison of multiple payloads indicating a payload identifier 503, a software identifier 505, a version 507, a format of the payload 509, and a pass/fail result of the comparison 511. Additionally, FIG. 6 illustrates example payloads 130A and 130B including indicators highlighting an element 605A, which is different than a corresponding element 605B.

### 7. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising a processor and a computer-readable data storage device storing program instructions that, when executed by the processor, cause the system to perform operations comprising:
storing a plurality of payloads generated by a plurality of software environments;
identifying a first payload of the plurality of payloads generated by a first software environment of the plurality of software environments;
identifying a second payload of the plurality of payloads generated by a second software environment of the plurality of software environments, wherein the second software environment comprises a modified version of the first software environment;
cleansing the first payload and the second payload by identifying a set of one or more elements for exclusion;
comparing elements of the first payload with respective elements of the second payload, wherein the comparing determines differences between the elements of the first payload and corresponding elements of the second payload;
excluding the set of one or more elements; and
generating a report indicating the differences.

2. The system of claim 1, wherein the operations further comprise:
based on a profile of the first payload or a profile of the second payload, selecting one or more preprocessing operations from a set of preprocessing operations including: formatting, validating, and sorting; and
performing the comparing after executing the selected one or more preprocessing operations without performing unselected preprocessing operations.

3. The system of claim 2, wherein the formatting comprises:
selecting a first schema of a plurality of schemas based on a file type of the first payload and the second payload; and
reformatting the first payload or the second payload using the first schema.

4. The system of claim 2, wherein the validating comprises:
selecting a first syntax of a plurality of syntaxes based on a file type of the first payload and the second payload; and
validating the first payload and the second payload using the first syntax.

5. The system of claim 1, wherein identifying the set of one or more elements for exclusion comprises:
selecting a first cleanse list of a plurality of cleanse lists based on a source of the first payload or the second payload,
wherein individual cleanse lists of the plurality of cleanse lists identify elements of the first payload and the second payload for exclusion from the comparing.

6. The system of claim 1, wherein identifying the set of one or more elements for exclusion comprises applying a trained machine learning model to the first payload or the second payload to compute the set of one or more elements.

7. The system of claim 1, wherein excluding the set of one or more elements comprises:
removing one or more elements from the first payload and the second payload along with values corresponding to the one or more elements.

8. The system of claim 1, wherein storing a plurality of payloads comprises receiving the plurality of payloads from a multithreaded computing infrastructure.

9. A method comprising:
storing a plurality of payloads generated by a plurality of software environments;
identifying a first payload of the plurality of payloads generated by a first software environment of the plurality of software environments;
identifying a second payload of the plurality of payloads generated by a second software environment of the plurality of software environments, wherein the second software environment comprises a modified version of the first software environment;
cleansing the first payload and the second payload by identifying a set of one or more elements for exclusion;
comparing elements of the first payload with respective elements of the second payload, wherein the comparing determines differences between the elements of the first payload and corresponding elements of the second payload;
excluding the set of one or more elements; and
generating a report indicating the differences.

10. The method of claim 9, further comprising:
based on a profile of the first payload or a profile of the second payload, selecting one or more preprocessing operations from a set of preprocessing operations including: formatting, validating, and sorting; and
performing the comparing after executing the selected one or more preprocessing operations without performing unselected preprocessing operations.

11. The method of claim 10, wherein the formatting comprises:
selecting a first schema of a plurality of schemas based on a file type of the first payload and the second payload; and
reformatting the first payload or the second payload using the first schema.

12. The method of claim 10, wherein the validating comprises:
selecting a first syntax of a plurality of syntaxes based on a file type of the first payload and the second payload; and
validating the first payload and the second payload using the first syntax.

13. The method of claim 9, wherein identifying the set of one or more elements for exclusion comprises:
selecting a first cleanse list of a plurality of cleanse lists based on a source of the first payload or the second payload,
wherein individual cleanse lists of the plurality of cleanse lists identify elements of the first payload and the second payload for exclusion from the comparing.

14. The method of claim 9, wherein identifying the set of one or more elements for exclusion comprises applying a trained machine learning model to the first payload or the second payload to compute the set of one or more elements.

15. The method of claim 9, wherein excluding the set of one or more elements comprises:
removing one or more elements from the first payload and the second payload along with values corresponding to the one or more elements.

16. The method of claim 9, wherein storing a plurality of payloads comprises receiving the plurality of payloads from a multithreaded computing infrastructure.

17. A non-transitory computer readable medium comprising instructions that, when executed by one or more hardware processes, causes performance of operations comprising:
storing a plurality of payloads generated by a plurality of software environments;
identifying a first payload of the plurality of payloads generated by a first software environment of the plurality of software environments;
identifying a second payload of the plurality of payloads generated by a second software environment of the plurality of software environments, wherein the second software environment comprises a modified version of the first software environment;
cleansing the first payload and the second payload by identifying a set of one or more elements for exclusion;
comparing elements of the first payload with respective elements of the second payload, wherein the comparing determines differences between the elements of the first payload and corresponding elements of the second payload;
excluding the set of one or more elements; and
generating a report indicating the differences.

18. The non-transitory computer readable medium of claim 17, wherein the operations further comprise:
based on a profile of the first payload or a profile of the second payload, selecting one or more preprocessing operations from a set of preprocessing operations including: formatting, validating, and sorting; and
performing the comparing after executing the selected one or more preprocessing operations without performing unselected preprocessing operations.

19. The non-transitory computer readable medium of claim 18, wherein the formatting comprises:
selecting a first schema of a plurality of schemas based on a file type of the first payload and the second payload; and
reformatting the first payload or the second payload using the first schema.

20. The non-transitory computer readable medium of claim 18, wherein the validating comprises:
selecting a first syntax of a plurality of syntaxes based on a file type of the first payload and the second payload; and
validating the first payload and the second payload using the first syntax.

21. The non-transitory computer readable medium of claim 17, wherein identifying the set of one or more elements for exclusion comprises:
selecting a first cleanse list of a plurality of cleanse lists based on a source of the first payload or the second payload,
wherein individual cleanse lists of the plurality of cleanse lists identify elements of the first payload and the second payload for exclusion from the comparing.

22. The non-transitory computer readable medium of claim 17, wherein identifying the set of one or more elements for exclusion comprises applying a trained machine learning model to the first payload or the second payload to compute the set of one or more elements.

23. The non-transitory computer readable medium of claim 17, wherein excluding the set of one or more elements comprises:
removing one or more elements from the first payload and the second payload along with values corresponding to the one or more elements.

24. The non-transitory computer readable medium of claim 17, wherein storing a plurality of payloads comprises receiving the plurality of payloads from a multithreaded computing infrastructure.
